(19) United States
(12) Patent Application Publication
(10) Pub. No.: US 2014/0155551 A1
(43) Pub. Date: Jun. 5, 2014

(54) PEROXIDE CURABLE FLUOROELASTOMER COMPOSITIONS

(71) Applicant: E I DU PONT DE NEMOURS AND COMPANY, Wilmington, DE (US)

(72) Inventor: STEVEN R. ORIANI, Landenberg, PA (US)

(73) Assignee: E I DU PONT DE NEMOURS AND COMPANY, Wilmington, DE (US)

(21) Appl. No.: 13/692,109

(22) Filed: Dec. 3, 2012

(51) Int. Cl. C08L 27/16

(52) U.S. Cl. CPC C08L 27/16
USPC 525/178

(57) ABSTRACT

Disclosed herein is a curable composition comprising a peroxide curable fluoroelastomer, an organic peroxide, a multifunctional coagent and a polyamide. Such curable compositions cure to a high degree in a short time.

### FIELD OF THE INVENTION

This invention relates to peroxide curable fluoroelastomer compositions comprising i) a peroxide curable fluoroelastomer, ii) an organic peroxide, iii) a multifunctional coagent and iv) a polyamide.

### BACKGROUND OF THE INVENTION

Fluoroelastomers having excellent heat resistance, oil resistance, and chemical resistance have been used widely for sealing materials, containers and hoses. Examples of fluoroelastomers include copolymers comprising units of vinylidene fluoride (VF₂) and units of at least one other copolymerizable fluorine-containing monomer such as hexafluoropropylene (HFP), tetrafluoroethylene (TFE), chlorotrifluoroethylene (CTFE), vinyl fluoride (VF), and a fluorovinyl ether such as a perfluoro(alkyl vinyl ether) (PAVE). Specific examples of PAVE include perfluoro(methyl vinyl ether), perfluoro(ethyl vinyl ether) and perfluoro(propyl vinyl ether).

In order to fully develop physical properties such as tensile strength, elongation, and compression set, elastomers must be cured, i.e. vulcanized or crosslinked. In the case of fluoroelastomers, this is generally accomplished by mixing uncured polymer (i.e. fluoroelastomer gum) with a polyfunctional curing agent and heating the resultant mixture, thereby promoting chemical reaction of the curing agent with active sites along the polymer backbone or side chains. Interchain linkages produced as a result of these chemical reactions cause formation of a crosslinked polymer composition having a three-dimensional network structure. Commonly employed curing agents for fluoroelastomers include the combination of an organic peroxide with a multifunctional coagent. A metal oxide is typically added to the composition in order to improve the cure response (i.e., both the state of cure and the rate of cure).

However, cured fluoroelastomer articles that contain metal oxides may exhibit unacceptably high volume swell, e.g. 50-200 vol. %, that can lead to seal failure, when seals are exposed to certain chemicals such as organic acids or biodiesel fuel for long periods of time or at elevated temperatures. The swelling can be minimized by eliminating metal oxides from the compositions, but elastomer physical properties at high temperature suffer and it may be difficult to cure the fluoroelastomer without any metal oxide present.

It has now been surprisingly discovered that when a peroxide curable fluoroelastomer composition contains a dispersion of polyamide particles, the composition cures well, both in the presence and in the absence of metal oxides.

### SUMMARY OF THE INVENTION

In one aspect, the present invention provides a curable fluoroelastomer composition comprising:
A) a peroxide curable fluoroelastomer;
B) an organic peroxide;
C) a multifunctional coagent; and
D) 0.5 wt % to 30 wt % polyamide, based on total weight of fluoroelastomer and polyamide.

In another aspect, the present invention provides a process for preparing a curable fluoroelastomer composition comprising the steps of
A) providing a peroxide curable fluoroelastomer;
B) providing a polyamide having a melting peak temperature or a glass transition temperature;
C) mixing said peroxide curable fluoroelastomer with said polyamide at a temperature greater than the melting peak temperature or glass transition temperature of the polyamide, whichever temperature is greater, to form a polymer blend comprising peroxide curable fluoroelastomer and 0.5 wt % to 30 wt % polyamide, based on total weight of fluoroelastomer and polyamide;
D) cooling the polymer blend to solidify the polyamide; and
E) adding a peroxide curative and a multifunctional coagent to said polymer blend at a temperature less than the melting peak temperature or glass transition temperature of the polyamide, whichever is less, to form a curable fluoroelastomer composition.

### DETAILED DESCRIPTION OF THE INVENTION

The present invention is directed to peroxide curable fluoroelastomer compositions that cure rapidly and to a high degree. The present invention is also directed to a process for preparing such curable compositions.

Fluoroelastomers that are suitable for use in this invention are those that are curable by an organic peroxide and multifunctional coagent.

By “peroxide curable” is meant fluoroelastomers that contain Br and/or I cure sites along the polymer chain, at chain ends or in both locations.

Cure sites along the fluoroelastomer chain are typically due to copolymerized cure site monomers that contain bromine or iodine atoms. Examples of suitable cure site monomers include, but are not limited to: i) bromine-containing olefins; ii) iodine-containing olefins; iii) bromine-containing vinyl ethers; and iv) iodine-containing vinyl ethers.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂(R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1 (ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of a bound iodine atom at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed in European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Specific examples of fluoroelastomers that may be employed in the invention include, but are not limited to copolymers comprising i) vinylidene fluoride (VF₂), hexafluoropropylene (HFP) and optionally tetrafluoroethylene (TFE), and ii) vinylidene fluoride, perfluoro(methyl vinyl ether) and optionally tetrafluoroethylene. All of the latter polymers having iodine or bromine atoms along the polymer chain, at the ends or both. Preferably the fluoroelastomers are copolymers of vinylidene fluoride (VF₂), hexafluoropropylene (HFP) and optionally tetrafluoroethylene (TFE) and contain less than 50 wt % copolymerized units of VF₂, most preferably less than 40 wt % copolymerized units of VF₂.

Polyamides that are useful in the compositions of the invention may be amorphous or semi-crystalline. Suitable polyamides are those having a melting peak temperature or glass transition temperature of greater than 160° C., preferably greater than 180° C., most preferably greater than 200° C. as determined in accordance with ASTM D3418-08. Preferably the polyamide is solid at the curing temperature of the fluoroelastomer, meaning that the curing temperature is less than the melting peak temperature or glass transition temperature, whichever is greater. While not wishing to be bound by theory, when the polyamide is not solid at the curing temperature, curative readily diffuses into the polyamide, rendering the blend difficult to cure. Polyamide resins are well known in the art and embrace those semi-crystalline resins having a weight average molecular weight of at least 5,000 and include those compositions commonly referred to as nylons. Thus, the polyamide component useful in the practice of the invention includes polyamides and polyamide resins such as nylon 6, nylon 7, nylon 6/6, nylon 6/10, nylon 6/12, nylon 11, nylon 12, polyamides comprising aromatic monomers, and polyamide block copolymers such as copoly(amide-ether) or copoly(amide-ester). The resins may be in any physical form, such as pellets and particles of any shape or size, including nanoparticles.

The viscosity of the polyamide resins can vary widely while meeting the aims of the present invention. To ensure that the polyamide becomes dispersed within a continuous phase of fluoroelastomer, it is desirable that the polyamide have an inherent viscosity greater than 0.9 dL/g, more preferably greater than 1.1 dL/g, and most preferably greater than 1.3 dL/g, as measured in accordance with ASTM D2857-95, using 96% by weight sulfuric acid as a solvent at a test temperature of 25° C.

In general, as the concentration of the polyamide in the fluoroelastomer blend increases, the use of a polyamide of higher inherent viscosity becomes more desirable. In certain embodiments, a polyamide with a high content of amine end groups, about 60 meq/Kg or greater, can be desirable and permits the use of a low viscosity polyamide of inherent viscosity of less than 0.9 dL/g. Such a high amine end group content may promote a grafting reaction between the fluoroelastomer and the polyamide amine end groups which can help to disperse the polyamide in the fluoroelastomer. If, during the blending process, the fluoroelastomer becomes dispersed in the polyamide, or the two phases become co-continuous, then the blend can become too viscous to further process at a temperature less than the peak melting temperature of the polyamide. Preferably, the fluoroelastomer—polyamide blend has a Mooney viscosity (ML1+10, 121° C.) of less than about 200.

The polyamide resin can be produced by condensation polymerization of equimolar amounts of a saturated dicarboxylic acid containing from 4 to 12 carbon atoms with a diamine, in which the diamine contains from 4 to 14 carbon atoms. To promote adhesion between the fluoroelastomer and the polyamide, preferably the polyamide will contain some amine end groups. Polyamide types polymerized from diacids and diamines may contain some molecules having two amine groups. In such cases, certain combinations of polyamide and fluoroelastomer can crosslink or gel slightly so as to produce compositions with compromised extrusion processability. Polyamide types prepared by ring opening polymerization reactions such as nylon 6, or those based solely on aminocarboxylic acids such as nylon 7 or 11 are most preferred because they avoid the possibility of crosslinking during blending with the fluoroelastomer. Such polyamide types contain molecules with at most one amine group each.

Examples of polyamides include polyhexamethylene adipamide (66 nylon), polyhexamethylene azelaamide (69 nylon), polyhexamethylene sebacamide (610 nylon) and polyhexamethylene dodecanoamide (612 nylon), the polyamide produced by ring opening of lactams, i.e. polycaprolactam, polylauriclactam, poly-11-aminoundecanoic acid, and bis(p-aminocyclohexyl)methanedodecanoamide. It is also possible to use polyamides prepared by the copolymerization of two of the above polymers or terpolymerization of the above polymers or their components, e.g. an adipic acid isophthalic acid hexamethylene diamine copolymer.

Typically, polyamides are condensation products of one or more dicarboxylic acids and one or more diamines, and/or one or more aminocarboxylic acids, and/or ring-opening polymerization products of one or more cyclic lactams. Polyamides may be fully aliphatic or semi-aromatic.

Fully aliphatic polyamides useful in practice of the present invention are formed from aliphatic and alicyclic monomers such as diamines, dicarboxylic acids, lactams, aminocarboxylic acids, and their reactive equivalents. A suitable aminocarboxylic acid is 11-aminododecanoic acid. Suitable lactams are caprolactam and laurolactam. In the context of this invention, the term “fully aliphatic polyamide” also refers to copolymers derived from two or more such monomers and blends of two or more fully aliphatic polyamides. Linear, branched, and cyclic monomers may be used.

Carboxylic acid monomers comprised in the fully aliphatic polyamides include, but are not limited to aliphatic carboxylic acids, such as for example adipic acid, pimelic acid, suberic acid, azelaic acid, decanedioic acid, dodecanedioic acid, tridecanedioic acid, tetradecanedioic acid, and pentadecanedioic acid. Diamines can be chosen from diamines having four or more carbon atoms, including, but not limited to tetramethylene diamine, hexamethylene diamine, octamethylene diamine, decamethylene diamine, dodecamethylene diamine, 2-methylpentamethylene diamine, 2-ethyltetramethylene diamine, 2-methyloctamethylenediamine; trimethylhexamethylenediamine, meta-xylylene diamine, and/or mixtures thereof.

Semi-aromatic polyamides are also suitable for use in the present invention. Such polyamides are homopolymers, dipolymers, terpolymers or higher order polymers formed from monomers containing aromatic groups. One or more aromatic carboxylic acids may be terephthalic acid or a mixture of terephthalic acid with one or more other carboxylic acids, such as isophthalic acid, phthalic acid, 2-methyl terephthalic acid and naphthalic acid. In addition, the one or more aromatic carboxylic acids may be mixed with one or more aliphatic dicarboxylic acids. Alternatively, an aromatic diamine such as meta-xylylene diamine can be used to provide a semi-aromatic polyamide, an example of which is a homopolymer comprising meta-xylylene diamine and adipic acid.

Block copoly(amide) copolymers are also suitable for use as the polyamide component provided the melting peak temperature of the polyamide block is at least 160° C. If a low softening point material comprises the block copoly(amide) copolymer, e.g., a polyether oligomer or a polyalkylene ether, for example, poly(ethylene oxide), then the block polymer will be a copoly(amide-ether). If a low softening point material of the block copoly(amide) copolymer comprises an ester, for example, a polylactone such as polycaprolactone, then the block copolymer will be a copoly(amide-ester). Any such low softening point materials may be used to form a block copoly(amide) copolymer. Optionally, the lower softening point material of the block copoly(amide) copolymer may comprise a mixture, for example, a mixture of any of the above-mentioned lower softening point materials. Furthermore, said mixtures of lower softening point materials may be present in a random or block arrangement, or as mixtures thereof. Preferably, the block copoly(amide) copolymer is a block copoly(amide-ester), a block copoly(amide-ether), or mixtures thereof. More preferably, the block copoly(amide) copolymer is at least one block copoly(amide-ether) or mixtures thereof. Suitable commercially available thermoplastic copoly(amide-ethers) include PEBAX® polyether block amides from Elf-Atochem, which includes PEBAX® 4033 and 6333. Most preferably, the polyamide is other than a block copoly(amide-ether) or copoly(amide-ester). Other polyamides have generally higher melting peak temperatures and are more effective in improving the cure response of the fluoroelastomer. Poly(amide-ethers) also exhibit poorer hot air aging as compared to conventional polyamides lacking a polyether block.

Preferred polyamides are homopolymers or copolymers wherein the term copolymer refers to polyamides that have two or more amide and/or diamide molecular repeat units.

The polyamide component may comprise one or more polyamides selected from Group I polyamides having a melting peak temperature of at least about 160° C., but less than about 210° C., and comprising an aliphatic or semiaromatic polyamide, for example poly(pentamethylene decanediamide), poly(pentamethylene dodecanediamide), poly(ε-caprolactam/hexamethylene hexanediamide), poly(ε-caprolactam/hexamethylene decanediamide), poly(12-aminododecanamide), poly(12-aminododecanamide/tetramethylene terephthalamide), and poly(dodecamethylene dodecanediamide); Group (II) polyamides having a melting peak temperature of at least about 210° C., and comprising an aliphatic polyamide selected from the group consisting of poly(tetramethylene hexanediamide), poly(ε-caprolactam), poly(hexamethylene hexanediamide), poly(hexamethylene dodecanediamide), and poly(hexamethylene tetradecanediamide); Group (III) polyamides having a melting peak temperature of at least about 210° C., and comprising about 20 to about 35 mole percent semiaromatic repeat units derived from monomers selected from one or more of the group consisting of (i) aromatic dicarboxylic acids having 8 to 20 carbon atoms and aliphatic diamines having 4 to 20 carbon atoms; and about 65 to about 80 mole percent aliphatic repeat units derived from monomers selected from one or more of the group consisting of an aliphatic dicarboxylic acid having 6 to 20 carbon atoms and said aliphatic diamine having 4 to 20 carbon atoms; and a lactam and/or aminocarboxylic acid having 4 to 20 carbon atoms; Group (IV) polyamides comprising about 50 to about 95 mole percent semi-aromatic repeat units derived from monomers selected from one or more of the group consisting of aromatic dicarboxylic acids having 8 to 20 carbon atoms and aliphatic diamines having 4 to 20 carbon atoms; and about 5 to about 50 mole percent aliphatic repeat units derived from monomers selected from one or more of the group consisting of an aliphatic dicarboxylic acid having 6 to 20 carbon atoms and said aliphatic diamine having 4 to 20 carbon atoms; and a lactam and/or aminocarboxylic acid having 4 to 20 carbon atoms; Group (V) polyamides having a melting peak temperature of at least about 260° C., comprising greater than 95 mole percent semi-aromatic repeat units derived from monomers selected from one or more of the group consisting of aromatic dicarboxylic acids having 8 to 20 carbon atoms and aliphatic diamines having 4 to 20 carbon atoms; and less than 5 mole percent aliphatic repeat units derived from monomers selected from one or more of the group consisting of an aliphatic dicarboxylic acid having 6 to 20 carbon atoms and said aliphatic diamine having 4 to 20 carbon atoms; and a lactam and/or aminocarboxylic acid having 4 to 20 carbon atoms. The polyamide may also be a blend of two or more polyamides.

Preferred polyamides include nylon 6, 6/6, 6/10, and Group IV and Group V polyamides having a melting peak temperature less than about 300° C. These polyamides have a melting peak temperature sufficiently high so as not to limit the scope of applications for the curable fluoroelastomer compositions, but not so high that production of the blends causes significant degradation of the fluoroelastomer. Also preferred are polyamides formed by ring opening or condensation of aminocarboxylic acids.

Polyamides suitable for use in the invention are widely commercially available, for example Zytel® resins, available from E. I. du Pont de Nemours and Company, Wilmington, Del., USA, Durethan® resins, available from Lanxess, Germany, and Ultramid® resins available from BASF, USA.

The polyamide level in the compositions of the invention is 0.5 wt % to 30 wt %, preferably 1 wt % to 10 wt %, most preferably 2 wt % to 5 wt %, based on total weight of fluoroelastomer and polyamide. Compositions of the invention may contain more than one fluoroelastomer and more than one polyamide.

Organic peroxides suitable for use in the compositions of the invention include, but are not limited to 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydroxyperoxide; di-t-butyl peroxide; t-butylcumyl peroxide; dicumyl peroxide; alpha, alpha′-bis(t-butylperoxy-m-isopropyl)benzene; 2,5-dimethyl-2,5-di(t-butylperoxy)hexane; 2,5-dimethyl-2,5-di(t-butylperoxy)hexene-3; benzoyl peroxide, t-butylperoxybenzene; 2,5-dimethyl-2,5-di(benzoylperoxy)-hexane; t-butylperoxymaleic acid; and t-butylperoxyisopropylcarbonate. Preferred examples of organic peroxides include 2,5-dimethyl-2,5-di(t-butylperoxy)hexane, dicumyl peroxide, and alpha, alpha′-bis(t-butylperoxy-m-isopropyl)benzene. The amount compounded is generally in the range of 0.05-5 parts by weight, preferably in the range of 0.1-3 parts by weight per 100 parts by weight of the fluoroelastomer. This particular range is selected because if the peroxide is present in an amount of less than 0.05 parts by weight, the vulcanization rate is insufficient and causes poor mold release. On the other hand, if the peroxide is present in amounts of greater than 5 parts by weight, the compression set of the cured polymer becomes unacceptably high. In addition, the organic peroxides may be used singly or in combinations of two or more types.

Multifunctional coagents employed in the curable compositions of this invention are polyfunctional unsaturated compounds such as triallyl cyanurate, trimethacryl isocyanurate, triallyl isocyanurate, trimethallyl isocyanurate, triacryl formal, triallyl trimellitate, N,N′-m-phenylene bismaleimide, diallyl phthalate, tetraallylterephthalamide, tri(diallylamine)-s-triazine, triallyl phosphite, bis-olefins and N,N-diallylacrylamide. The amount compounded is generally in the range of 0.1-10 parts by weight per 100 parts by weight of the fluoroelastomer. This particular concentration range is selected because if the coagent is present in amounts less than 0.1 part by weight, crosslink density of the cured polymer is unacceptable. On the other hand, if the coagent is present in amounts above 10 parts by weight, it blooms to the surface during molding, resulting in poor mold release characteristics. The preferable range of coagent is 0.2-6 parts by weight per 100 parts fluoroelastomer. The unsaturated compounds may be used singly or as a combination of two or more types.

Optionally acid acceptors (e.g. metal oxides or hydroxides such as zinc oxide, magnesium oxide, calcium hydroxide, etc.) commonly employed in peroxide curable fluoroelastomer compositions may be employed in the compositions of the invention. However, preferably the compositions of the invention are substantially free of acid acceptors. By “substantially free” is meant less than 0.1 (preferably 0) parts by weight per hundred parts by weight fluoroelastomer.

The polymer blend component of the curable peroxide curable fluoroelastomer compositions of the invention may be formed by mixing the polyamide component into the fluoroelastomer component at temperatures above the melting peak temperature of the polyamide, or at temperatures above the glass transition temperature of the polyamide, whichever is greater, under conditions that do not produce a dynamic cure of the fluoroelastomer. This is followed by cooling the thus-produced polymer blend to form a polyamide/fluoroelastomer composition. That is, curative will not be present when the polyamide component and fluoroelastomer component are being mixed. This is because the mixing temperature specified is above that at which crosslinking and/or gelling of the fluoroelastomer will occur if curative were present.

Cooling of the composition formed by mixing the fluoroelastomer component and polyamide component serves to crystallize the polyamide domains so that the polyamide becomes solid and therefore cannot coalesce to form a continuous phase upon subsequent mixing, e.g., when mixed with peroxide curative and multifunctional coagent to form a curable composition. The temperature below which the blend must be cooled can be determined by measuring the crystallization peak temperature of the polyamide in the blend (or glass transition temperature if an amorphous polyamide) according to ASTM D3418-08. The polyamide/fluoroelastomer blend compositions may exhibit multiple crystallization peak temperatures. In such cases, the lowest crystallization peak temperature is taken as the temperature below which the blend must be cooled to fully solidify the polyamide component. Generally, the blend will be cooled to 40° C. or less, which is sufficient to solidify the polyamides useful in the practice of the present invention.

The cooled fluoroelastomer/polyamide blend, organic peroxide curative, multifunctional coagent and any other ingredients are generally incorporated into a curable composition by means of an internal mixer or rubber mill at a temperature less than the melting peak temperature or glass transition temperature of the polyamide, whichever is less. Other ingredients that may be added include those commonly employed in fluororubber compositions, e.g. fillers, plasticizers, colorants, process aids, etc.

The resulting curable composition may then be shaped (e.g. molded or extruded) and cured to form a fluororubber article. Curing typically takes place at about 150°-200° C. for 1 to 60 minutes. Conventional rubber curing presses, molds, extruders, and the like provided with suitable heating and curing means can be used. Also, for optimum physical properties and dimensional stability, it is preferred to carry out a post curing operation wherein the molded or extruded fluororubber article is heated in an oven or the like for an additional period of about 1-48 hours, typically from about 180°-275° C.

### EXAMPLES

Materials

| | |
|---|---|
| FKM-1 | Fluoroelastomer comprising 36% vinylidene fluoride (VF₂), 34% |
| | hexafluoropropylene (HFP), 28.4% tetrafluoroethylene (TFE), |
| | and 1.6% 4-bromo-3,3,4,4-tetrafluorobutene-1 (BTFB). Mooney |
| | viscosity (ML1 + 10, 121° C.) of 23. All percentages are by |
| | weight unless otherwise indicated. |
| FKM-2 | Fluoroelastomer comprising 36% VF₂, 34.1% HFP, 28.2% TFE, |
| | and 1.7% BTFB. The polymer contains 0.07% iodine resulting |
| | from an iodine containing chain transfer agent. Mooney |
| | viscosity (ML1 + 10, 121° C.) of 30. |
| FKM-3 | Fluoroelastomer comprising 50.2% VF₂, 29.2% HFP, 20% TFE, |
| | and 0.6% BTFB. The polymer contains 0.2% iodine resulting |
| | from an iodine containing chain transfer agent. Mooney |
| | viscosity (ML1 + 10, 121° C.) of 26. |
| FKM-4 | Fluoroelastomer comprising 60% VF₂ and 40% HFP. Mooney |
| | viscosity (ML1 + 10, 121° C.) of 25. |
| FKM-5 | Fluoroelastomer comprising 36.3% VF₂, 36% HFP, 27.5% TFE, |
| | 0.2% 4-iodo-3,3,4,4-tetrafluorobutene-1 (ITFB) cure site. The |
| | polymer contains 0.22 wt % iodine resulting from the ITFB cure |
| | site and an iodine containing chain transfer agent. Mooney |
| | viscosity (ML1 + 10, 121° C.) of 44. |
| PA-1 | Polyamide copolymer comprising copolymerized units of |
| | hexamethylene diamine, adipic acid, and terephthalic acid, |
| | melting peak temperature of approximately 262° C., amine end |
| | group concentration of about 74 meq/kg, and inherent viscosity |
| | of 0.892 dL/g. |
| PA-2 | Polyamide 6/10, having a melting peak temperature of |
| | approximately 225° C., amine end group concentration of about |
| | 63 meq/kg, and inherent viscosity of 1.167 dL/g. |
| PA-3 | Polyamide 6, inherent viscosity of 1.450 dL/g, melting peak |
| | temperature of 220° C., available from BASF Corp. as |
| | Ultramid ® B40. |
| PA-4 | Amorphous polyamide with a glass transition midpoint of about |
| | 125° C., and amine end group content of about 30 meq/Kg. |
| Coagent | Triallylisocyanurate, available from DuPont as Diak ® 7 |
| Per- | 2,5-dimethyl-2,5-di(t-butylperoxy)hexane, available from |
| oxide | Arkema as Luperox ® 101 and R T Vanderbilt as Varox ® |
| | DBPH |
| Zinc | Kadox ® 911, available from HallStar Corp. |
| oxide | |
| Carbon | Available from Cancarb Corp. as Thermax ® N990 |
| black | |

### Test Methods

Mooney viscosity: ASTM D1646, ML 1+10, 121° C.

Cure response: Measured per ASTM D5289-07a using an MDR 2000 from Alpha Technologies operating at 0.5° arc. Test temperature and length of test as specified. ML refers to the minimum torque value measured during the test, while MH refers to the maximum torque value attained after ML. t50 and t90 refer to the time to 50% and 90% torque, respectively, of the difference between MH and ML.

Thermal transitions: Melting peak temperature and glass transition temperature measured in accordance with ASTM D3418-08.

### Example 1

Blends B1 and B2 of fluoroelastomer and polyamide were prepared having compositions as shown in Table 1, by mixing the polymers at a temperature greater than the melting peak temperature of the polyamide.

Blend B1 was prepared from fluoroelastomer FKM-1 comprising brominated cure sites and polyamide PA-1. Melt mixing was carried out using a Haake® Rheocord mixing bowl fitted with roller blades, operating at a set temperature of 20° C. greater than the melting peak temperature of the polyamide. Polymers were charged to the mixing bowl at a rotor speed of about 30 rpm. When the polymer was fully charged, and the polymer melt temperature recovered to the melting peak temperature of the polyamide, the rotor speed was set to 100 rpm, and a timer was started. The batch was mixed for 3 minutes, while controlling the batch temperature within a range of 15° to 25° C. greater than the melting peak temperature of the polyamide. The batch was then removed from the mixing bowl and cooled to room temperature before further processing.

Blend B2 was prepared from FKM-4, a fluoroelastomer lacking bromine or iodine cure sites, and polyamide PA-1. Melt mixing was carried out using a 25 mm Berstorff twin screw extruder operating at a setpoint of 20° C. greater than the melting peak temperature of the polyamide, with a screw speed of 150 rpm. The polyamide was added via a weight loss feeder to the first barrel section of the extruder, while the fluoroelastomer was added at a downstream barrel section using a feeder designed for elastomers from The Bonnot Company. The blend was collected on a water cooled belt, and allowed to cool to room temperature before further processing.

TABLE 1

| Blend, wt % | B1 | B2 |
|---|---|---|
| FKM-1 | 80 | |
| FKM-4 | | 85 |
| PA-1 | 20 | 15 |

FKM-1 and blends B1 and B2 were compounded with peroxide, coagent, and optionally zinc oxide by roll mill mixing, thereby producing curable compositions of the invention C1, C2, and comparative examples CE1-CE3, as shown in Table 2. The cure response data in Table 2 shows that composition CE1, comprising FKM-1, without zinc oxide or polyamide, exhibits virtually no torque increase (MH-ML of only 0.1 dN-m). CE2 demonstrates that further addition of zinc oxide to CE1 produces a large torque increase, though the cure rate is slow (t90 of 6.6 minutes). C1 exhibits excellent cure response, with a larger torque increase and shorter t90 than CE2, but without zinc oxide. C2 shows that further addition of zinc oxide to C1 slightly improves the torque increase, but t90 becomes longer. CE3 demonstrates that a fluoroelastomer lacking both bromine and iodine cure sites, even in the presence of both polyamide and zinc oxide, exhibits a weak cure response of only 1.2 dN-m torque increase.

TABLE 2

| | CE1 | CE2 | C1 | C2 | CE3 |
|---|---|---|---|---|---|
| Composition, phr¹ | | | | | |
| FKM-1 | 100 | 100 | | | |
| B1 | | | 125 | 125 | |
| B2 | | | | | 117.6 |
| Peroxide | 1.5 | 1.5 | 1.5 | 1.5 | 2.4 |
| Coagent | 2.5 | 2.5 | 2.5 | 2.5 | 1.9 |
| Zinc oxide | | 3 | | 3 | 2 |
| Cure response, 177° C., | | | | | |
| 12 minutes | | | | | |
| ML (dN-m) | 0.1 | 0.1 | 0.9 | 0.8 | 0.6 |
| MH (dN-m) | 0.2 | 5.8 | 8.1 | 9.4 | 1.8 |
| t90 (min) | * | 6.6 | 2.6 | 4.9 | 1.6 |
| Delta torque | 0.1 | 5.7 | 7.2 | 8.6 | 1.2 |
| MH − ML (dN- | | | | | |
| m) | | | | | |

¹parts by weight per hundred parts by weight rubber (i.e. fluoroelastomer)
* cure response too weak to determine t90

### Example 2

A series of polyamide blends B3-B9 using FKM-3, a fluoroelastomer comprising both iodine and bromine cure sites, and PA-1, PA-2, PA-3, or PA-4 were produced as shown in Table 3. The polyamide levels in these blends ranged from 2 wt % to 20 wt %. Blend B10, also shown in Table 3, comprises a fluoroelastomer with iodine cure sites (FKM-5) and 30 wt % PA-2. All blends in Table 3 were prepared as described for blend B1 of Example 1, with the exception of blend B9. Blend B9 comprises PA-4, which is completely amorphous, and therefore does not have a peak melting temperature from which to determine the mixing temperature. Blend B9 was mixed as if PA-4 has a melting peak temperature of 180° C.

TABLE 3

| Blend, | | | | | | | | |
|---|---|---|---|---|---|---|---|---|
| wt % | B3 | B4 | B5 | B6 | B7 | B8 | B9 | B10 |
| FKM-3 | 90 | 90 | 80 | 90 | 95 | 98 | 80 | |
| FKM-5 | | | | | | | | 70 |
| PA-1 | 10 | | | | | | | |
| PA-2 | | 10 | | | | | | 30 |
| PA-3 | | | 20 | 10 | 5 | 2 | | |
| PA-4 | | | | | | | 20 | |

Curable compositions CE4 and C3-C10 were produced by roll mill mixing of peroxide and curative into FKM-3 and blends B3-B10, as shown in Table 4. No zinc oxide was used in any of the compositions. CE4 comprised FKM-3 without polyamide, and therefore cured weakly. C3-C10, on the other hand, all showed large torque increases, even using polyamide levels as low as 2 wt %. C3-C8 and C10 comprise polyamides having a melting peak temperature greater than the temperature at which the cure response was measured, i.e., greater than 177° C. C3-C8 and C10 all cure quickly, with a short t90 of 1.2 to 1.4 minutes. C9, however, exhibits a much longer t90, of 9.5 minutes, because the polyamide PA-4 is fluid at the cure temperature. It is believed that when the polyamide becomes fluid at the cure temperature, i.e., the cure temperature is greater than both the melting peak temperature (if one is present) and the glass transition temperature of the polyamide, that the curative diffuses readily into the polyamide and slows the rate of cure.

TABLE 4

| Composition, phr | CE4 | C3 | C4 | C5 | C6 | C7 | C8 | C9 | C10 |
|---|---|---|---|---|---|---|---|---|---|
| FKM-3 | 100 | | | | | | | | |
| B3 | | 111.1 | | | | | | | |
| B4 | | | 111.1 | | | | | | |
| B5 | | | | 125 | | | | | |
| B6 | | | | | 111.1 | | | | |
| B7 | | | | | | 105.3 | | | |
| B8 | | | | | | | 102 | | |
| B9 | | | | | | | | 125 | |
| B10 | | | | | | | | | 142.9 |
| Peroxide | 1.5 | 1.5 | 1.5 | 1.5 | 1.5 | 1.5 | 1.5 | 1.5 | 1.5 |
| Coagent | 3 | 3 | 3 | 3 | 3 | 3 | 3 | 2.4 | 3 |

Cure response, 177° C., 12 minutes

| | | | | | | | | | |
|---|---|---|---|---|---|---|---|---|---|
| ML (dN-m) | 0.2 | 0.7 | 0.7 | 0.7 | 0.7 | 0.5 | 0.5 | 1 | 4.5 |
| MH (dN-m) | 1 | 12.1 | 13.2 | 14.3 | 13.4 | 10.7 | 9.5 | 10.5 | 27.5 |
| t90 (min) | * | 1.4 | 1.4 | 1.3 | 1.4 | 1.3 | 1.3 | 9.5 | 1.2 |
| Delta torque MH-ML | 0.8 | 11.4 | 12.5 | 13.6 | 12.7 | 10.2 | 9 | 9.5 | 23 |
| (dN-m) | | | | | | | | | |

* cure response too weak to determine t90

### Example 3

This example demonstrates that a melt mixed polyamide-fluoroelastomer blend, in which the fluoroelastomer comprises iodine and/or bromine cure sites, may be diluted at a mixing temperature below the melting peak temperature of the polyamide with a fluoroelastomer having bromine and/or iodine cure sites, while retaining excellent cure response. Composition C11 comprises blend B5, FKM-3, peroxide, and coagent as shown in Table 5. These ingredients were mixed on a roll mill at a temperature less than 70° C. to form composition C11, such that the weight percent of polyamide in the resulting fluoroelastomer—polyamide blend is 11.1%. C11 exhibits excellent cure response, similar to C5.

TABLE 5

| | C11 |
|---|---|
| Composition, phr | |
| FKM-3 | 50 |
| B5 | 62.5 |
| Peroxide | 1.7 |
| Coagent | 3.4 |
| Cure response, | |
| 177° C., 12 minutes | |
| ML (dN-m) | 0.7 |
| MH (dN-m) | 14.3 |
| t90 (min) | 1.4 |
| Delta torque MH − ML | 13.6 |
| (dN-m) | |

### Example 4

This example shows the advantage of the compositions of the invention when exposed to organic acids. Blend B11 was produced according to the method in Example 1 for blend B2. The composition of B11 is shown in Table 6.

TABLE 6

| Blend, wt % | B11 |
|---|---|
| FKM-3 | 95.8 |
| PA-3 | 4.2 |

FKM-3 and blend B11 were roll mill mixed with ingredients as shown in Table 7 to produce curable compositions CE4 and C12. Both compounds exhibited good cure response. Plaques approximately 2 mm thick were press cured at 180° C. for 10 min from both compounds.

Samples of the cured plaques were then immersed in 1M acetic acid for 168 hours at 100° C., and the volume increase after the exposure was measured. C12 showed significantly lower volume increase than CE4.

TABLE 7

| | CE4 | C12 |
|---|---|---|
| Composition, phr | | |
| FKM-2 | 100 | |
| B11 | | 105 |
| Peroxide | 1.5 | 1.5 |
| Coagent | 3 | 3 |
| Zinc oxide | 3 | |
| Carbon black | 30 | 25 |
| Cure response, 180° C., | | |
| 10 minutes | | |
| ML (dN-m) | 0.8 | 0.9 |
| MH (dN-m) | 16.3 | 17.7 |
| t90 (min) | 1.6 | 1.2 |
| Delta torque MH − ML | 15.5 | 16.8 |
| (dN-m) | | |
| Volume increase in | | |
| 1M acetic acid, | | |
| 168 hours at 100° C. | | |
| (%) | 54 | 16 |

What is claimed is:

1. A curable fluoroelastomer composition comprising:
A) a peroxide curable fluoroelastomer;
B) an organic peroxide;
C) a multifunctional coagent; and
D) 0.5 wt % to 30 wt % polyamide, based on total weight of fluoroelastomer and polyamide.

2. The curable composition of claim 1 wherein said fluoroelastomer is a copolymer of vinylidene fluoride and hexafluoropropylene, said copolymer having iodine or bromine cure sites.

3. The curable composition of claim 2 wherein said copolymer further comprises tetrafluoroethylene.

4. The curable composition of claim 3 wherein said copolymer contains less than 50 wt % vinylidene fluoride.

5. The curable composition of claim 4 wherein said copolymer contains less than 40 wt % vinylidene fluoride.

6. The curable composition of claim 1 wherein said polyamide has a melting peak temperature greater than 160° C.

7. The curable composition of claim 6 wherein said polyamide has a melting peak temperature greater than 180° C.

8. The curable composition of claim 7 wherein said polyamide has a melting peak temperature greater than 200° C.

9. The curable composition of claim 1 substantially free from a metal oxide.

10. A process for preparing a curable fluoroelastomer composition comprising the steps of
A) providing a peroxide curable fluoroelastomer;
B) providing a polyamide having a melting peak temperature or a glass transition temperature;
C) mixing said peroxide curable fluoroelastomer with said polyamide at a temperature greater than the melting peak temperature or glass transition temperature of the polyamide, whichever temperature is greater, to form a polymer blend comprising peroxide curable fluoroelastomer and 0.5 wt % to 30 wt % polyamide, based on total weight of fluoroelastomer and polyamide;
D) cooling the polymer blend to solidify the polyamide; and
E) adding a peroxide curative and a multifunctional coagent to said polymer blend at a temperature less than the melting peak temperature or glass transition temperature of the polyamide, whichever is less, to form a curable fluoroelastomer composition.

11. The process for preparing a curable fluoroelastomer composition of claim 10 wherein said fluoroelastomer is a copolymer of vinylidene fluoride and hexafluoropropylene, said copolymer having iodine or bromine cure sites.

12. The process for preparing a curable fluoroelastomer composition of claim 11 wherein said copolymer further comprises tetrafluoroethylene.

13. The process for preparing a curable fluoroelastomer composition of claim 10 wherein said polyamide has a melting peak temperature greater than 160° C.

14. The process for preparing a curable fluoroelastomer composition of claim 13 wherein said polyamide has a melting peak temperature greater than 180° C.

15. The process for preparing a curable fluoroelastomer composition of claim 14 wherein said polyamide has a melting peak temperature greater than 200° C.
